(19) United States
(12) Patent Application Publication
(10) Pub. No.: US 2005/0198129 A1
(43) Pub. Date: Sep. 8, 2005

(54) Methods and systems for providing communications management

(76) Inventors: Robert Samuel Bolen, Pasadena, MD (US); Irene A. Lericos, Glen Arm, MD (US); Susan Renee Brennan, Springfield, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/864,026

(22) Filed: Jun. 9, 2004

Related U.S. Application Data
(60) Provisional application No. 60/477,107, filed on Jun. 9, 2003.

(51) Int. Cl. G06F 15/16

(52) U.S. Cl. 709/204

(57) ABSTRACT

Systems and methods for providing communications management may comprise receiving a current request. In addition, the systems and methods may comprise determining a current message in response to the current request wherein the current message is based on at least one of a plurality of previous messages corresponding to previous requests. In addition, the systems and methods may comprise providing the current message.

### RELATED APPLICATION

Under provisions of 35 U.S.C. § 119(e), this Application claims the benefit of U.S. Provisional Application No. 60/477,107, filed Jun. 9, 2003, which is incorporated herein by reference.

### BACKGROUND

I. Technical Field

The present invention generally relates to providing communications management. More particularly, the present invention relates to providing communications management regarding contacts with the news media.

II. Background Information

The United States Postal Service (USPS) is an independent government agency that provides mail delivery and other services to the public. The USPS is widely recognized as a safe and reliable means for sending and receiving mail and other items. With the advent and steady growth of electronic mail and electronic commerce, the physical mail stream will increasingly be utilized for sending and receiving packages and other items.

Most national or international enterprises include a department of communications professionals who coordinate corporate messaging through, for example, speechwriting, media/public relations, product publicity, and employee communications. Occasionally, enterprises such as corporations and business institutions encounter crises that may necessitate, for example, the public and/or the news media being informed regarding the crises. Examples of such crises may include the cyanide-laced Tylenol® and the anthrax-contaminated mail incidents. Pressures may mount on the enterprise and information may come from multiple sources within or without the enterprise sometimes resulting in rumors and inaccurate information. Currently, much time is spent in manually researching, editing, and clearing responses to the news media, for example. In many cases, such responses may still be inconsistent or outside an enterprise's policies. Regarding such crises, a program that may convey accurate and consistent information from one source is desired.

Consequently, providing communications management is desired. Great inefficiencies are created in conventional communications management processes because, for example, much time is spent in manually researching, editing, and clearing responses to the news media. Moreover, such conventional communications management processes produce responses that may be inconsistent or outside an enterprise's policies. Accordingly, providing communications management remains an elusive goal. Thus, there remains a need for efficiently providing communications management. In addition, there remains a need for efficiently providing communications management regarding contacts with the news media.

### SUMMARY

Consistent with embodiments of the present invention, systems and methods are disclosed for providing communications management.

In accordance with one embodiment, a method for providing communications management comprises receiving a current request, determining a current message in response to the current request wherein the current message is based on at least one of a plurality of previous messages corresponding to previous requests, and providing the current message.

In accordance with another embodiment, a system for providing communications management comprises a storage memory for maintaining a database and a processing unit coupled to the storage memory wherein the processing unit is operative to receive a current request, determine a current message in response to the current request wherein the current message is based on at least one of a plurality of previous messages corresponding to previous requests, and provide the current message.

In accordance with yet another embodiment, a computer-readable medium which stores a set of instructions which when executed performs a method for providing communications management, the method executed by the set of instructions comprises receiving a current request, determining a current message in response to the current request wherein the current message is based on at least one of a plurality of previous messages corresponding to previous requests, and providing the current message.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an illustration of a communications management process consistent with an embodiment of the present invention;

FIG. 2 is a block diagram of a communications management system consistent with an embodiment of the present invention; and

FIG. 3 is a flow chart of an exemplary method for providing communications management consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

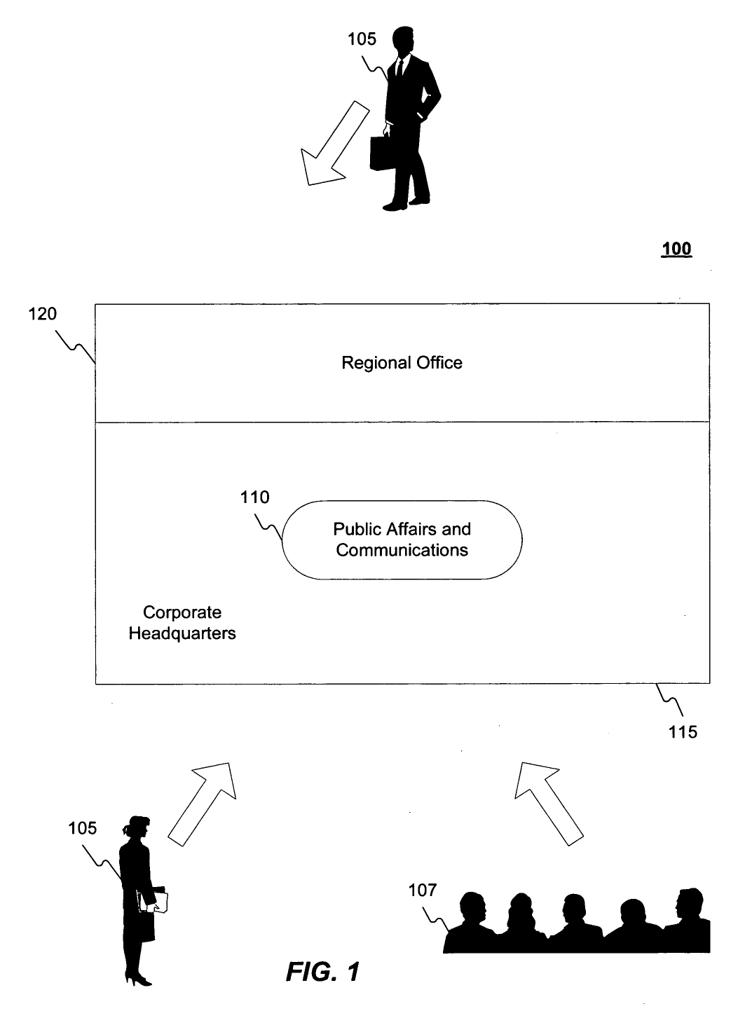

Systems and methods consistent with embodiments of the present invention may provide communications management associated with an enterprise such as, for example, the USPS. FIG. 1 illustrates a communications management process consistent with an embodiment of the present invention. Many enterprises, such as an enterprise 100, may include a centralized department within the enterprise, the primary function of which is dealing with, for example, a news media 105 and/or a general public 107. Such a department may comprise a public affairs and communications (PA&C) department 110. For example, PA&C 110 may comprise a nationwide network of communications professionals who coordinate corporate messaging through speechwriting, media/public relations, product publicity, and employee communications. PA&C 110 may be located in a corporate headquarters 115 and may include staff (not shown) in a regional office 120.

PA&C 110 may manage internal and external communications for enterprise 100. PA&C 110 may include both headquarters and field staff across the country. The PA&C staff at headquarters 115 may be responsible for handling media issues that are deemed national in scope. The PA&C staff at regional office 120 may be responsible for the local application of national issues, the regional needs of their specific geographic area, as well as internal communication, for example.

PA&C 110 may seek to satisfy, for example, four main goals. A first goal may be to align all enterprise messaging, for example, to provide one voice and one message. A second goal may be to provide a more effective and efficient system by providing real-time information that is centralized and easily accessible. A third goal may be to develop a process for media management and events promotions. Finally, a fourth goal may be to develop a process for recording and storing metadata needed to demonstrate the effectiveness of PA&C 110's efforts.

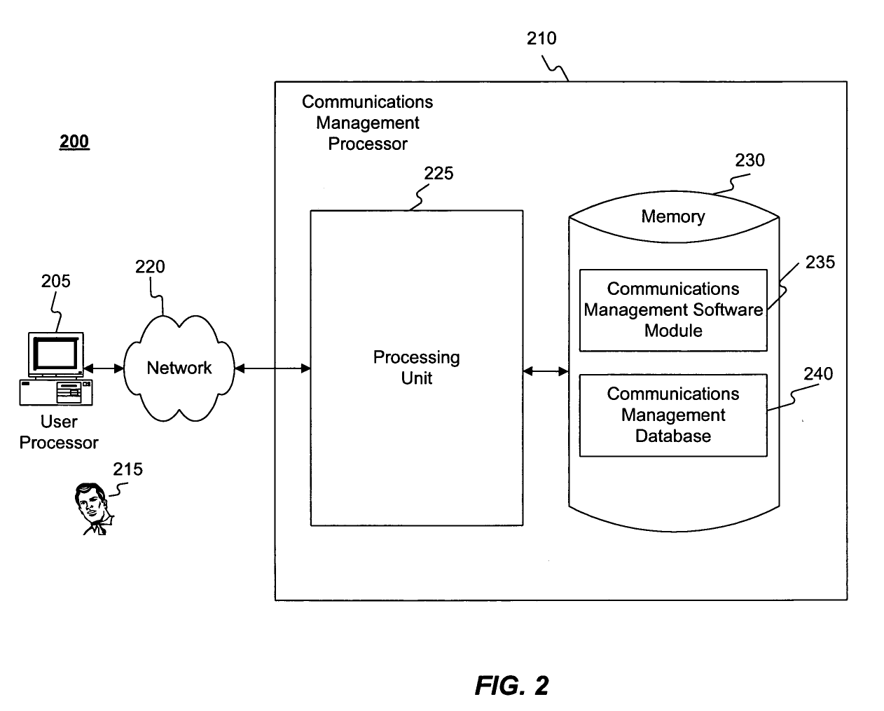

Because PA&C 110 may deal with national and local media outlets PA&C 110 may use, for example, a system that may provide the capability to speak with one voice and one message in as close to real time as possible. This system may comprise communications management system 200 as described below with respect to FIG. 2. PA&C 110 may use system 200 to better manage and to monitor contacts between members of news media 105 and PA&C 110's staff who regularly handle and manage news media inquiries.

By way of a non-limiting example, FIG. 2 illustrates system 200 in which the features and principles of the present invention may be implemented. As illustrated in the block diagram of FIG. 2, system 200 may include user processor 205, communications management processor 210, a user 215, and a network 220. User 215 may be an individual, for example, desiring to communicate with an enterprise using user processor 210. User 215 may also be an organization, enterprise, or any other entity having such desires.

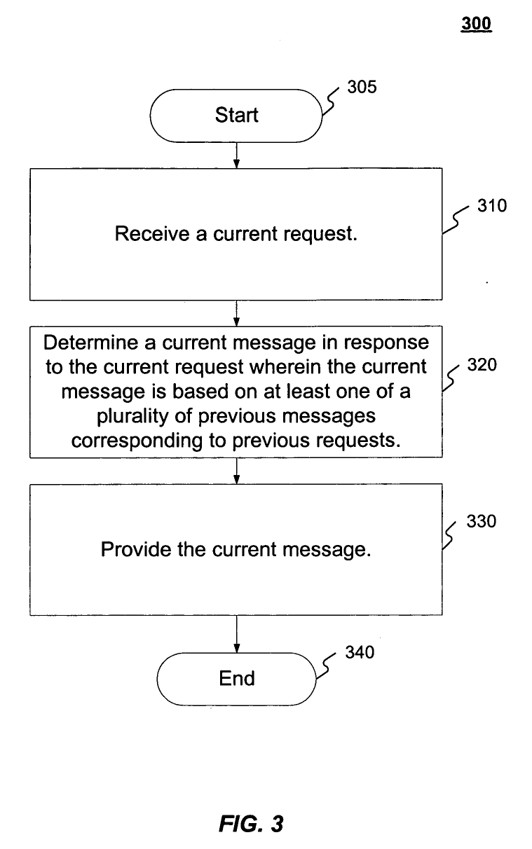

Communications management processor 210 may include a processing unit 225 and a memory 230. Memory 230 may include a communications management software module 235 and a communications management database 240. For example, communications management software module 235, executed on processing unit 225, may access communications management database 240 and implement processes for providing communications management such as the exemplary method described below with respect to FIG. 3.

System 200 may, for example, include a restricted-access, password-protected communications management database 240 that helps tracks contacts between news media 105 and news media representatives of enterprise 100. System 200 may categorize each contact by type of media, size of media, type of information sought, and disposition of call. System 200 may provide customized displays that may display only information useful to a particular user, such as a news organization or a reporter, or only information pertaining to a subject or issue. The user may program the system to display only inquiries from news media in a particular geographic region or to display inquiries from major media organizations across the country. The database may be continuously updated and may be accessed twenty-four hours a day, seven days a week by, for example, authorized enterprise representatives such as PA&C 110's staff.

For incoming news media requests, a database entry in communications management database 240 may be made via a use template. Each entry may include the following information: i) time and date of the inquiry; ii) media organization and address; iii) a reporter's name, telephone number, and e-mail address; iv) inquiry topic; v) a reporter's story deadline (time frame for the enterprise's response); vi) enterprise spokesperson; and vii) status of inquiry.

Moreover, the communications management system may comprise a secure, web-based computer application designed to ensure one-voice, one-message communication. Such web-based application may significantly improve the management and flow of information from, for example, an enterprise's management to its employees, media, and the public. Communications management system 210 may significantly reduces time previously spent in manually researching, editing, and clearing responses to the news media and in the preparation and dissemination of messages to enterprise stakeholders in real time.

The communications management system may make PA&C 110 a more dynamic and proactive department. Converting processes that are performed manually to an automated environment may reduce redundancy and duplication of effort. By managing and tracking enterprise messaging from concept to end-user, with metrics to gauge effectiveness, more precise future modifications and upgrades may be possible.

The communications management system may comprise two components: i) a PA&C Media Desktop (or PAC MD); and ii) a PA&C Resource Exchange (or PAC Rx.) The PAC MD may be a virtual workspace located on an enterprise Intranet, for example. The resources available through the PAC MD may provide PA&C 110's managers, staff, and relevant officers with resources that are up-to-date, searchable, and immediately and easily accessed. The support provided by PAC Rx may ensure that enterprise policies, procedures, and business practices are followed and to make certain that the drain on PA&C 110's managers and staff, in terms of their time and labor commitment, is minimal. Converting processes that are performed manually to an automated environment may reduce redundancy and duplication of effort.

Furthermore, the communications management system may be a secure access system crafted specifically to meet the needs and requirements of top managements and its staff. This system may be used to support the communication needs of enterprise 100 and to enhance tracking and manageability of communications metadata, effort, and accountability.

An embodiment consistent with the invention may comprise a system for providing communications management. The system may comprise a storage memory for maintaining a database and a processing unit coupled to the storage memory. The processing unit may be operative to receive a current request. Furthermore, the processing unit may be operative to determine a current message in response to the current request wherein the current message is based on at least one of a plurality of previous messages corresponding to previous requests. In addition, the processing unit may be operative to provide the current message.

Consistent with an embodiment of the present invention, the aforementioned memory, processing unit, and other components may be implemented in a communications management system, such as an exemplary communications management system 200 of FIG. 2. Any suitable combination of hardware, software and/or firmware may be used to implement the memory, processing unit, or other components. By way of example, the memory, processing unit, or other components may be implemented with any of a user processor 205 or communications management processor 210, in combination in system 200. The aforementioned system and processors are exemplary and other systems and processors may comprise the aforementioned memory, processing unit, or other components, consistent with embodiments of the present invention.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general-purpose computer or in any other circuits or systems.

User processor 205 or communications management processor 210 (“the processors”) included in system 200 may be implemented using a personal computer, network computer, mainframe, or other similar microcomputer-based workstation. The processors may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 220 may comprise, for example, a local area network (LAN) or a wide area network (WAN). Such networking environments are commonplace in offices, enterprise-wide computer networks, intranets, and the Internet, and are known by those skilled in the art. When a LAN is used as network 220, a network interface located at any of the processors may be used to interconnect any of the processors. When network 220 is implemented in a WAN networking environment, such as the Internet, the processors may typically include an internal or external modem (not shown) or other means for establishing communications over the WAN. Further, in utilizing network 220, data sent over network 220 may be encrypted to insure data security by using known encryption/decryption techniques.

In addition to utilizing a wireline communications system as network 220, a wireless communications system, or a combination of wireline and wireless may be utilized as network 220 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission.

System 200 may also transmit data by methods and processes other than, or in combination with, network 220. These methods and processes may include, but are not limited to, transferring data via, diskette, CD ROM, facsimile, flash memory sticks, conventional mail, an interactive voice response system (IVR), or via voice over a publicly switched telephone network.

FIG. 3 is a flow chart setting forth the general stages involved in an exemplary method 300 consistent with the invention for providing communications management using system 200 of FIG. 2. Exemplary ways to implement the stages of exemplary method 300 will be described in greater detail below. Exemplary method 300 may begin at starting block 305 and proceed to stage 310 where processor 210 may receive a current request. For example, processor 210 may receive the current request from user 215 over network 220 using processor 205. User 115 may represent a media enterprise. The media enterprise may comprise a local media enterprise, a national media enterprise, or an international media enterprise, for example. The current request may include, for example; i) a media enterprise's name; ii) a media enterprise's address; iii) a reporter's name; iv) a reporter's telephone number; v) a reporter's e-mail address; vi) the current request's topic; vii) a time frame in which the current message is needed; and viii) a person to which the current request is directed. Moreover, the current request may be directed to a public relations person, for example, a member of PA&C 110.

From stage 310, where processor 210 receives the current request, exemplary method 300 may advance to stage 320 where processor 210 may determine a current message in response to the current request. The current message may be based on at least one of a plurality of previous messages corresponding to previous requests. For example, once the current request is received at processor 210, a PA&C 110 member may determine the current message in response to the current request. The PA&C 110 member may analyze one or more of a plurality of previous messages corresponding to previous requests and may establish the current message consistent with the one or more of the plurality of previous messages. Furthermore, the current message may be established consistent with policies established by enterprise 100. When establishing the current message, the PA&C 110 member may query database 240, which may include the plurality of previous messages corresponding to the previous requests, to identify the at least one of a plurality of previous messages corresponding to previous requests. The query maybe based on one of a media type, a media size, a media enterprise providing the current request, the type of information sought by the current request, a reporter's name, and a geographic region.

Once processor 210 determines the current message in response to the current request in stage 320, exemplary method 300 may continue to stage 330 where processor 210 may provide the current message. For example, the PA&C 110 member may send the current message to user 115 over network 220. After processor 210 provides the current message in stage 330, exemplary method 300 may then end at stage 340.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

1. A method for providing communications management, the method comprising:
receiving a current request;
determining a current message in response to the current request wherein the current message is based on at least one of a plurality of previous messages corresponding to previous requests; and
providing the current message.

2. The method of claim 1, wherein receiving the current request comprises receiving the current request from a media enterprise.

3. The method of claim 2, wherein receiving the current request comprises receiving the current request from one of a local media enterprise, a national media enterprise, or an international media enterprise.

4. The method of claim 1, wherein receiving the current request comprises receiving at least one of a media enterprise's name, a media enterprise's address, a reporter's name, a reporter's telephone number, a reporter's e-mail address, the current request's topic, a time frame in which the current message is needed, a person to which the current request is directed, or a department to which the current request is directed.

5. The method of claim 1, wherein receiving the current request comprises receiving the current request directed to a public relations person.

6. The method of claim 1, wherein determining the current message in response to the current request comprises:
analyzing the at least one of the plurality of previous messages corresponding to the previous requests; and
establishing the current message wherein the current message is consistent with the at least one of the plurality of previous messages.

7. The method of claim 6, wherein providing the current message comprises establishing the current message consistent with policies established by an enterprise establishing the current message.

8. The method of claim 1, wherein determining the current message in response to the current request comprises querying a database comprising the plurality of previous messages corresponding to the previous requests to identify the at least one of a plurality of previous messages corresponding to previous requests, the query based on at least one of a media type, a media size, a media enterprise providing the current request, the type of information sought by the current request, a reporter's name, or a geographic region.

9. A system for providing communications management, the system comprising:
a storage memory for maintaining a database; and
a processing unit coupled to the storage memory, wherein the processing unit is operative to
receive a current request;
determine a current message in response to the current request wherein the current message is based on at least one of a plurality of previous messages corresponding to previous requests; and
provide the current message.

10. The system of claim 9, wherein the processing unit being operative to receive the current request further comprises the processing unit being operative to receive the current request from a media enterprise.

11. The system of claim 10, wherein the processing unit being operative to receive the current request further comprises the processing unit being operative to receive the current request from the media enterprise comprising one of a local media enterprise, a national media enterprise, or an international media enterprise.

12. The system of claim 9, wherein the processing unit being operative to receive the current request further comprises the processing unit being operative to receive the current request comprising at least one of a media enterprise's name, a media enterprise's address, a reporter's name, a reporter's telephone number, a reporter's e-mail address, the current request's topic, a time frame in which the current message is needed, a person to which the current request is directed, or a department to which the current request is directed.

13. The system of claim 9, wherein the processing unit being operative to receive the current request further comprises the processing unit being operative to receive the current request directed to a public relations person.

14. The system of claim 9, wherein the processing unit being operative to determine the current message in response to the current request further comprises the processing unit being operative to:
analyze the at least one of the plurality of previous messages corresponding to the previous requests; and
establish the current message wherein the current message is consistent with the at least one of the plurality of previous messages.

15. The system of claim 14, wherein the processing unit being operative to establish the current message further comprises the processing unit being operative to establish the current message consistent with policies established by an enterprise establishing the current message.

16. The system of claim 9, wherein the processing unit being operative to determine the current message in response to the current request further comprises the processing unit being operative to query a database comprising the plurality of previous messages corresponding to the previous requests to identify the at least one of a plurality of previous messages corresponding to previous requests, the query based on at least one of a media type, a media size, a media enterprise providing the current request, the type of information sought by the current request, a reporter's name, or a geographic region.

17. A computer-readable medium which stores a set of instructions which when executed performs a method for providing communications management, the method executed by the set of instructions comprising:
receiving a current request;
determining a current message in response to the current request wherein the current message is based on at least one of a plurality of previous messages corresponding to previous requests; and
providing the current message.

18. The computer-readable medium of claim 17, wherein receiving the current request comprises receiving the current request from a media enterprise.

19. The computer-readable medium of claim 18, wherein receiving the current request comprises receiving the current request from the media enterprise comprising one of a local media enterprise, a national media enterprise, or an international media enterprise.

20. The computer-readable medium of claim 23, wherein receiving the current request comprises receiving the current request comprising at least one of a media enterprise's name, a media enterprise's address, a reporter's name, a reporter's telephone number, a reporter's e-mail address, the current request's topic, a time frame in which the current message is needed, a person to which the current request is directed, or a department to which the current request is directed.

21. The computer-readable medium of claim 17, wherein receiving the current request comprises receiving the current request directed to a public relations person.

22. The computer-readable medium of claim 17, wherein determining the current message in response to the current request comprises:
analyzing the at least one of the plurality of previous messages corresponding to the previous requests; and
establishing the current message wherein the current message is consistent with the at least one of the plurality of previous messages.

23. The computer-readable medium of claim 22, wherein establishing the current message comprises establishing the current message consistent with policies established by an enterprise establishing the current message.

24. The computer-readable medium of claim 22, wherein determining the current message in response to the current request comprises querying a database comprising the plurality of previous messages corresponding to the previous requests to identify the at least one of a plurality of previous messages corresponding to previous requests, the query based on at least one of a media type, a media size, a media enterprise providing the current request, the type of information sought by the current request, a reporter's name, or a geographic region.
